(19) United States
(12) Patent Application Publication
(10) Pub. No.: US 2014/0365285 A1
(43) Pub. Date: Dec. 11, 2014

(54) MECHANISM FOR DONATING TO CHARITY WHILE BUYING GOODS AND SERVICES ONLINE

(71) Applicant: Microsoft Corporation, Redmond, WA (US)

(72) Inventors: Eric Bahna, Seattle, WA (US); Anshul Rawat, Kirkland, WA (US); Aaron Butcher, Redmond, WA (US)

(21) Appl. No.: 13/914,654

(22) Filed: Jun. 11, 2013

(51) Int. Cl. G06Q 30/02; G06Q 30/06

(52) U.S. Cl. CPC G06Q 30/0279; G06Q 30/0633; G06Q 30/0222
USPC 705/14.23; 705/26.8

(57) ABSTRACT

In one embodiment, a centralized internet commerce platform allows a user to donate to charity as part of an internet purchase. The centralized internet commerce platform 122 may present a sales item of a vendor for purchase. The centralized internet commerce platform 122 may receive from a user a purchase order 300 for the sales item. The centralized internet commerce platform 122 may divert a charity donation from the purchase order 300 to a charity account 150.

### BACKGROUND

A user may purchase a sales item over a data network, such as the internet. A sales item may be an application, a media content piece, a product, or a service package. An application is a software program that may be downloaded to a user device. A media content piece is a set of digital media, such as a movie, a song, or an e-book. A product is any physical product that may be shipped to a consumer. A service package is a set of services performed offline for the consumer, such as accounting or custom craftwork.

A vendor may post these sales items or offers for these items from a vendor server to a commerce server executing a centralized internet commerce platform. A centralized internet commerce platform provides a point of sale for multiple vendors in a central online location. The centralized internet commerce platform may handle the financial transactions. The centralized internet commerce platform may receive a purchase order from the user. The purchase order may identify the sales item that the user wants to purchase. The purchase order may also contain secure payment information allowing funds to be securely transferred from the user to the vendor. For digital sales items, such as an application or a media content piece, the user may download the sales item from the centralized internet commerce platform. For physical products or service packages, the centralized internet commerce platform may establish a communication session between the vendor and the user to facilitate completion of the transaction.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to donating to charity as part of an internet purchase. The centralized internet commerce platform may present a sales item of a vendor for purchase. The centralized internet commerce platform may receive from a user a purchase order for the sales item. The centralized internet commerce platform may divert a charity donation from the purchase order to a charity account.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a commerce network.

FIG. 2 illustrates, in a block diagram, one embodiment of a computing device.

FIG. 3 illustrates, in a block diagram, one embodiment of a purchase order.

FIG. 4 illustrates, in a block diagram, one embodiment of a charity report.

FIG. 5 illustrates, in a flowchart, one embodiment of a method for executing a charity transaction.

FIG. 6 illustrates, in a flowchart, one embodiment of a method for determining a charity account.

FIG. 7 illustrates, in a flowchart, one embodiment of a method for diverting a charity donation.

FIG. 8 illustrates, in a flowchart, one embodiment of a method for creating a charity report.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a centralized internet commerce platform.

A vendor may post a description of a sales item to a server on the internet. The server may be a commerce server acting as a centralized internet commerce platform. The centralized internet commerce platform may handle the purchase of the sales item provides a point of sale for multiple vendors in a central online location. A user device may send a purchase order to the centralized internet commerce platform indicating the item the user wants to purchase and containing secure payment information to transfer funds from the user to the vendor. The centralized internet commerce platform may handle transactions for multiple independent vendors.

Often the purchase price of a sales item, especially when taxes and other transaction costs are included, tends to produce an irregular price point. The centralized internet commerce platform may, with the user's permission, round the purchase price up to a round number, with the extra money being donated by the centralized internet commerce platform to a charity organization. For example, if a movie costs $12.83 to download, the user may pay $13.00, with 17 cents being donated to the Seattle Children's Hospital®. Alternately, a user may specify a set amount be donated to charity with each purchase. For example, the user may specify that $1 be donated to a San Francisco homeless shelter with each purchase. The charity may be chosen by the user or suggested by the vendor. The user may donate as part of a purchase without any input from the vendor.

Additionally, the vendor may also have money deducted from the transaction at the centralized internet commerce platform to donate to charity. The vendor may match the user's contribution, or donate a set amount with each purchase. The vendor may leverage the trustworthiness of the centralized internet commerce platform provider, who may often be better known than the vendor, so that the user knows that the donation is being performed. For example, a small game developer selling a game on the Microsoft Xbox® may use Microsoft's reputation to assure a user about promised donations to charity. Further, a charity may benefit from the aggregation of a multitude of users donating small amounts. As the amounts may be small, a charity may more readily entice a user to donate, while the large number of users may lead to a large total donation.

The centralized internet commerce platform may track the charity donations and provide the user with a charity report at reporting intervals. The reporting intervals may be monthly or yearly. Alternately, the centralized internet commerce platform may issue a charity report each time a purchase occurs, or after a set number of purchases. The user may use the charity report for charitable deductions when filing taxes. The charity report may also describe to users other charities to which other purchasers of the sales item have donated. The charity report may further describe the total donations to a charity via the centralized internet commerce platform over a set period. The receiving charity may send an expenditure report to the centralized internet commerce platform for inclusion with the charity report. The user may then see where the donation of that user was directed.

The centralized internet commerce platform may incentivize the donation process by providing a charity award, such as a charity badge. A user may receive a charity badge to post in a social network to encourage donations for a chosen cause. Alternately, the centralized internet commerce platform may post the charity badge to the social network directly. The charity badge may be improved or modified with subsequent donations to one or more charities. Further, the centralized internet commerce platform may organize the donations as a game, with each donation unlocking further achievement levels. An alternate charity award may be a specialized gaming item or user avatar. For example, the user that donates to the Seattle Children's Hospital® may receive a special shield with the Seattle Children's Hospital® logo to use in a fighting video game.

Thus, in one embodiment, a centralized internet commerce platform allows a user to donate to charity as part of an internet purchase. The centralized internet commerce platform may present a sales item of a vendor for purchase. The centralized internet commerce platform may receive from a user a purchase order for the sales item. The centralized internet commerce platform may divert a charity donation from the purchase order to a charity account.

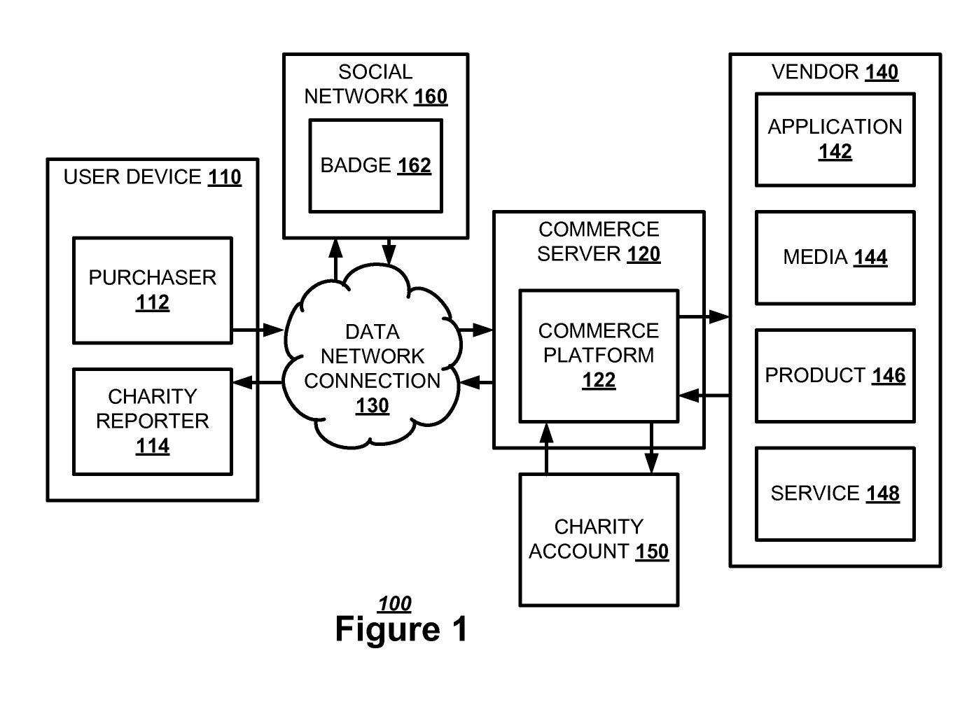

FIG. 1 illustrates, in a block diagram, one embodiment of a commerce network 100. A user device 110 may access a commerce server 120 operating a centralized internet commerce platform 122 via a data network connection 130. A user device 110 may be a desktop computer, a laptop computer, a tablet computer, or a handheld “smart phone”. The data network connection 130 may be an internet connection, a wide area network connection, a local area network connection, or other type of data network connections.

The centralized internet commerce platform 122 processes the purchase of sales items provided by a vendor server 140. The sales items may be an application 142, a media content piece 144, a product 146, or a service package 148. A listing of the sales items may be formatted and presented by either a vendor server 140 or the centralized internet commerce platform 122. The user device 110 may be executing a purchasing application 112 that allows the user to create a purchase order to purchase sales items from the centralized internet commerce platform 122, either as a native application or in a web browser. The purchase order may identify the user, the sales item, and the secure payment information so that the centralized internet commerce platform may transfer the funds for the sales item from the user to the vendor. A purchase order price describes the amount deducted from the account of the user, such as the sales item price, any applicable taxes, services and handling charges, and any charitable donations added to the purchase transaction.

At the direction of the user, the centralized internet commerce platform 122 may divert a charity donation from the purchase order to a charity account 150 for a charity organization. The charity organization may be any charitable, political, or other organization that accepts donations. The charity account 150 may be established by the user, the vendor, or a third party. The user may select the charity account 150 at the time of purchase. Alternately, the user may designate that certain types of purchases go to certain charity organizations, such as designating that movie purchases have charity donations to the Salvation Army® and game purchases have charity donations to the Red Cross®. Further, the user may tie the charity designation to the charity donation amount.

A user charity donation is a charity donation that the user adds on top of the sales item price plus taxes. A vendor charity donation is a charity donation that is paid by the vendor. The vendor may deduct the donation from the sales item price, make a set donation with each purchase, match a user donation, or make some other arrangement. The charity donation may be composed of a user charity donation, a vendor charity donation, a third party donation, or some combination of donations by different parties. The user may set the donation amount at the time of purchase. Alternately, the user may have the purchase order price rounded up to the nearest unit amount, with the rounding amount used as the charity donation. For example, if the purchase order price after taxes and processing is $48.67, the user may round the purchase order price to $50.00, with $1.33 being the charity donation. The vendor charity donation may match the user charity donation. So in the above example, the vendor may receive $47.34 with $2.66 going to the charity account 150.

The centralized internet commerce platform 122 may send the whole donation to a charity selected by the vendor. Alternately, the user may designate one or more charities to receive the donation. For multiple charities, the user may designate which charity receives which percentage of the donation. For example, the user may designate that a specific charity receive 40% of the donation for each purchase, while the other charities receive a percentage of the donation on an ad hoc basis.

Once the charity donation has been diverted, the centralized internet commerce platform 122 may generate a charity report. The centralized internet commerce platform 122 may receive an organization expenditure report from the charity organization describing the actions the charity organization has taken with the money. The charity report may also describe a user aggregate donation for the year, so that the user may claim these charity donations as a tax deduction. The charity report may also describe a sales item aggregate donation, so that the user may see which sales items have produced donations for which charity. Further, the charity report may describe the sum total of donations to a specific charity, either by sales item or by users of the centralized internet commerce platform 122. The centralized internet commerce platform 122 may send the charity report to the user device 110, the vendor, or the charity organization. The charity report sent to the charity may describe each item that lead to a charity donation. The charity report sent to the vendor may describe each item that lead to a charity donation, as well as the amount donated. The charity report may be sent at regular time intervals or after a set number of purchases.

The user device 110 may execute a charity report application 114 to display the charity report back to the user. The charity report application 114 may be integrated with another application, such as the purchasing application 112. The charity report may be formatted for reading by the charity report application 114, an e-mail reader, or a simple text reader.

The centralized internet commerce platform 122 may create a charity award to encourage further donations. The centralized internet commerce platform 122 may post directly to a social network 160 a charity badge 162 describing the user's donations to promote further donations by the user's social contacts. Alternately, the centralized internet commerce platform 122 may send the charity badge or some other type of charity award to the user device 110. In addition to the charity badge 162, the charity award may be a program enhancement, user avatar or other feature.

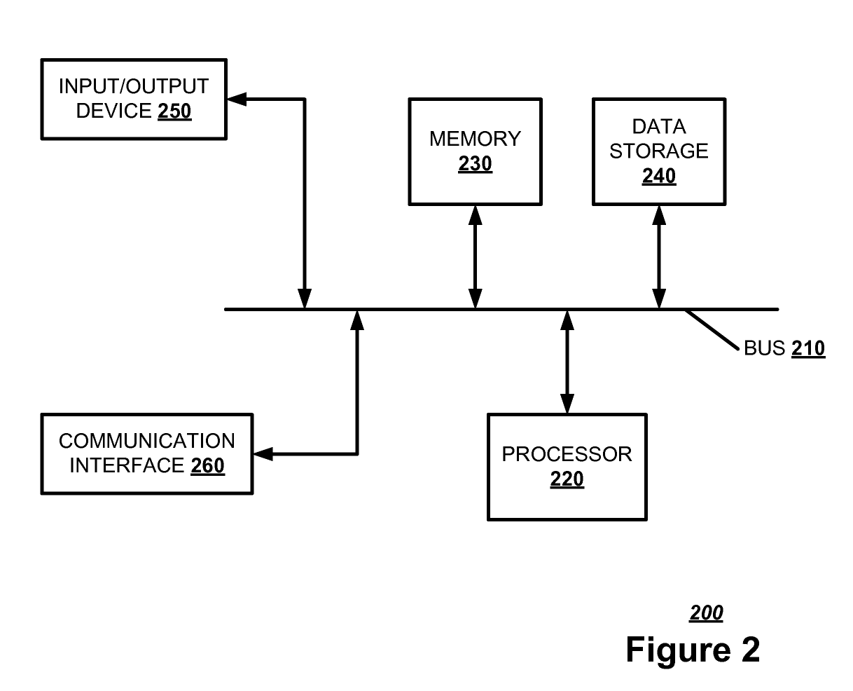

FIG. 2 illustrates a block diagram of an exemplary computing device 200 which may act as a user device 110, a commerce server 120, or a vendor server 140. The computing device 200 may combine one or more of hardware, software, firmware, and system-on-a-chip technology to implement a user device 110, a commerce server 120, or a vendor server 140. The computing device 200 may include a bus 210, a processor 220, a memory 230, a data storage 240, an input/output device 250, and a communication interface 260. The bus 210, or other component interconnection, may permit communication among the components of the computing device 200.

The processor 220 may include at least one conventional processor or microprocessor that interprets and executes a set of instructions. The memory 230 may be a random access memory (RAM) or another type of dynamic data storage that stores information and instructions for execution by the processor 220. The memory 230 may also store temporary variables or other intermediate information used during execution of instructions by the processor 220. The data storage 240 may include a conventional ROM device or another type of static data storage that stores static information and instructions for the processor 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing sales items or charity account 150 information.

The input/output device 250 may include one or more conventional mechanisms that permit a user to input information to the computing device 200, such as a keyboard, a mouse, a voice recognition device, a microphone, a headset, a gesture recognition device, a touch screen, etc. The input/output device 250 may include one or more conventional mechanisms that output information to the user, including a display, a printer, one or more speakers, a headset, or a medium, such as a memory, or a magnetic or optical disk and a corresponding disk drive. The communication interface 260 may include any transceiver-like mechanism that enables computing device 200 to communicate with other devices or networks. The communication interface 260 may include a network interface or a transceiver interface. The communication interface 260 may be a wireless, wired, or optical interface.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

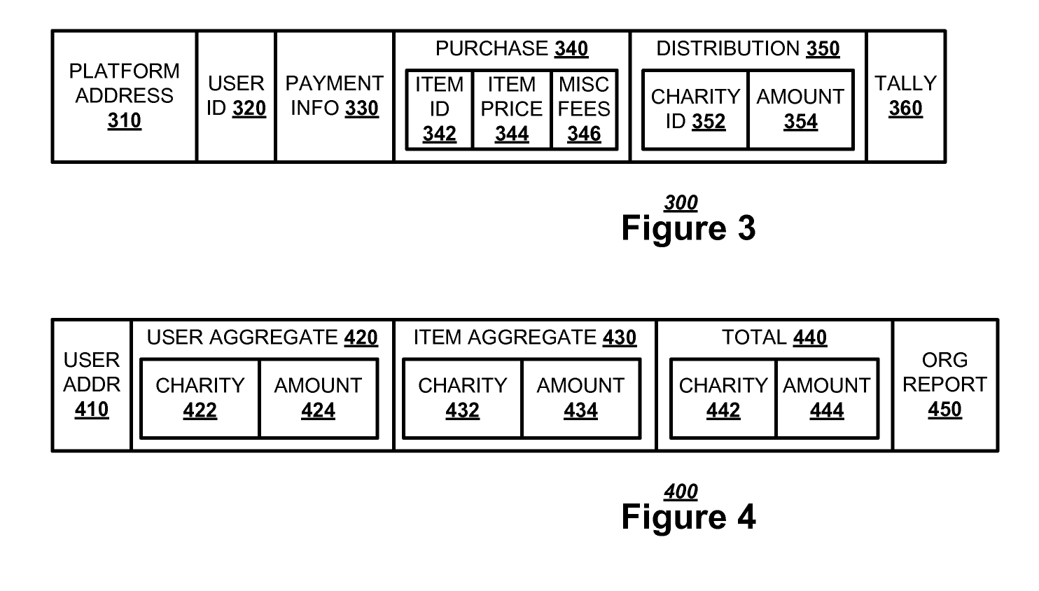

FIG. 3 illustrates, in a block diagram, one embodiment of a purchase order 300. The purchase order 300 may have a commerce platform address 310, identifying the centralized internet commerce platform that is to receive the purchase order 300. The purchase order 300 may have a user identifier (ID) 320 describing the user device 110 sending the purchase order 300. The purchase order 300 may have secure payment information 330 describing the payment account and routing information that the user is using to pay for the purchase order 300. The purchase order 300 may have a purchase description 340 describing each item purchased in the purchase order 300. For each item purchased, the purchase description 340 may have an item identifier 342 describing the one or more sales items that the user wishes to purchase, the sales item price 344 for that item, and any miscellaneous fees 346 associated with the sale of the item, such as taxes, shipping, and handling. The purchase order 300 may have a charity distribution description 350 describing the distribution for any charity donation by the user. For each charity receiving a donation, the charity distribution description 350 may have a charity identifier 352 specifying the charity account 150 receiving the charity donation and the amount 354 that charity is receiving. The purchase order 300 may have a tally field 360 describing the total amount of money the user is providing in the purchase order 300, both purchases and charity donations.

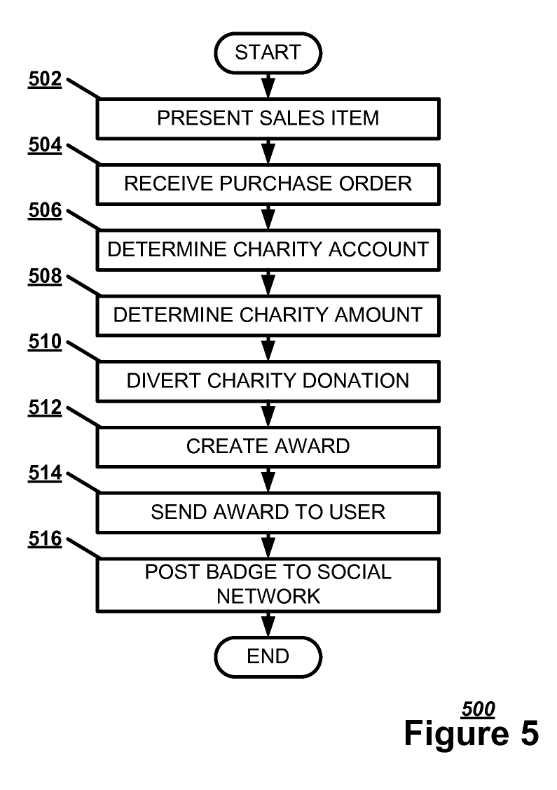

FIG. 4 illustrates, in a block diagram, one embodiment of a charity report 400. The charity report 400 may have a user address (USER ADDR) 410 identifying the user device 110 receiving the charity report 400. The charity report 400 may have a user aggregate donation 420 describing the total user donations for the reporting period. The user aggregate donation 420 may contain a description of each user charity 422 and the user donation amount 424. The charity report 400 may have a sales item aggregate donation 430 describing the total donations associated with the purchase of a sales item purchased by the user for the reporting period, including donations by other users while purchasing the sales item. The sales item aggregate donation amount 430 may contain a description of each sales item charity 432 and the sales item donation amount 434. The charity report 400 may have a donation total 440 describing the total donations to a charity from the centralized internet commerce platform 122 for the reporting period. The donation total 440 may contain a description of each charity 442 and the donation amount 444 to that charity 442. The charity report 400 may have an organization expenditure report 450. The organization expenditure report 450, received from the charity organization owning the charity account, describes how the charity organization used the funds donated.

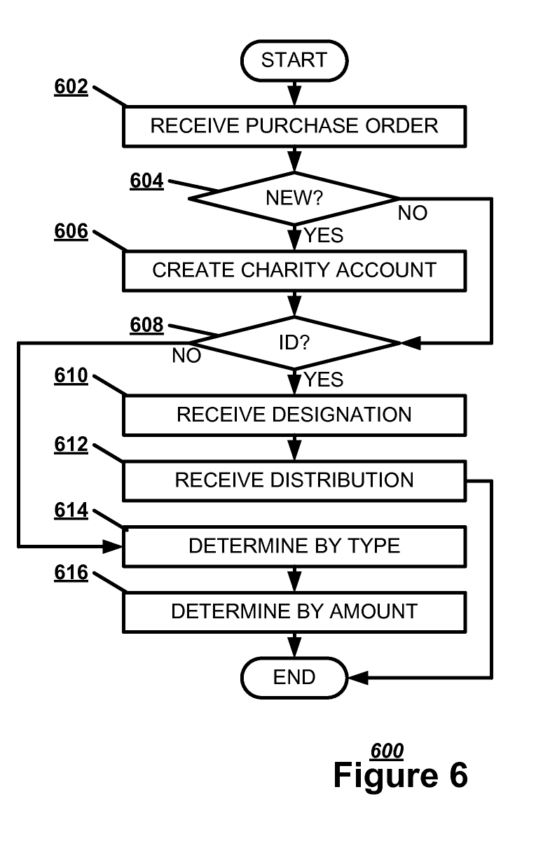

FIG. 5 illustrates, in a flowchart, one embodiment of a method 500 for executing a charity transaction. The centralized internet commerce platform 122 may present a sales item of a vendor for purchase (Block 502). The centralized internet commerce platform 122 may receive from a user a purchase order 300 for the sales item (Block 504). The centralized internet commerce platform 122 may determine a charity account 150 to receive a charity donation (Block 506). The centralized internet commerce platform 122 may determine a charity amount for the charity donation (Block 508). The centralized internet commerce platform 122 may divert the charity donation from the purchase order 300 to the charity account 150 (Block 510). The centralized internet commerce platform 122 may create a charity award, such as a charity badge 162, upon completion of the purchase order 300 (Block 512). The centralized internet commerce platform 122 may send the charity award to the user (Block 514). Additionally, the centralized internet commerce platform 122 may post a charity badge 162 directly to a social network 160 (Block 516).

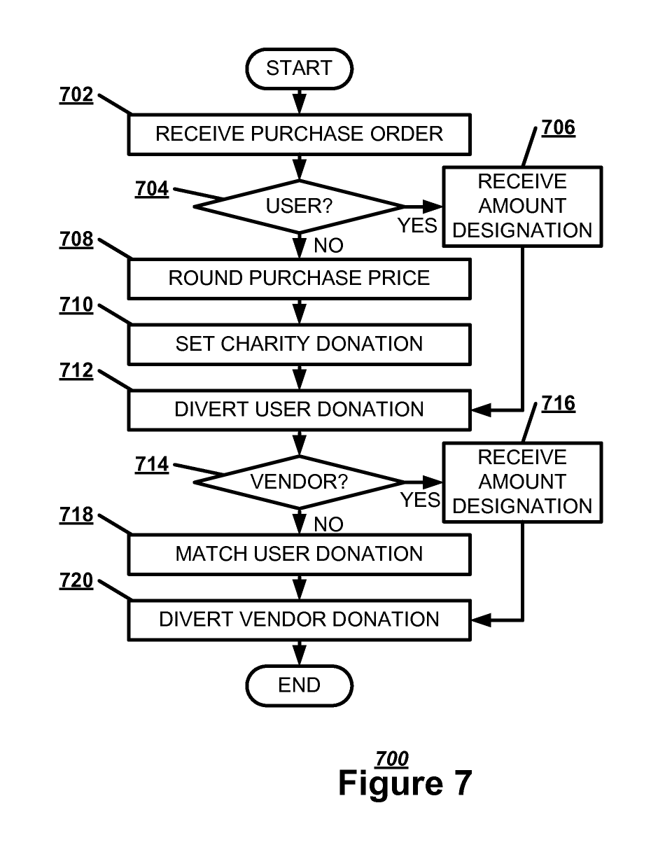

FIG. 6 illustrates, in a flowchart, one embodiment of a method 600 for determining a charity account 150. The centralized internet commerce platform 122 may receive from a user a purchase order 300 for a sales item (Block 602). If the purchase order 300 indicates that the user wants to donate to a new charity not yet in the system (Block 604), the centralized internet commerce platform 122 may create a charity account 150 based on a user description (Block 606). If the purchase order 300 identifies an existing charity account 150 the user wishes to donate to or the sales item description specifies an existing charity account (Block 608), the centralized internet commerce platform 122 may receive a charity designation from at least one of the user or the vendor (Block 610). For multiple charities, the centralized internet commerce platform 122 may receive a charity distribution from the user indicating which charities get which percentage of the donation (Block 612). Otherwise, the centralized internet commerce platform 122 may determine the charity account based in part on a purchase type, or the type of sales item purchased (Block 614). For example, the user may specify that a game purchase results in a donation to a local food bank. The centralized internet commerce platform 122 may determine the charity account based in part on a charity donation amount (Block 616). For example the user may specify that a donation over a certain amount may result in a donation to a local synagogue.

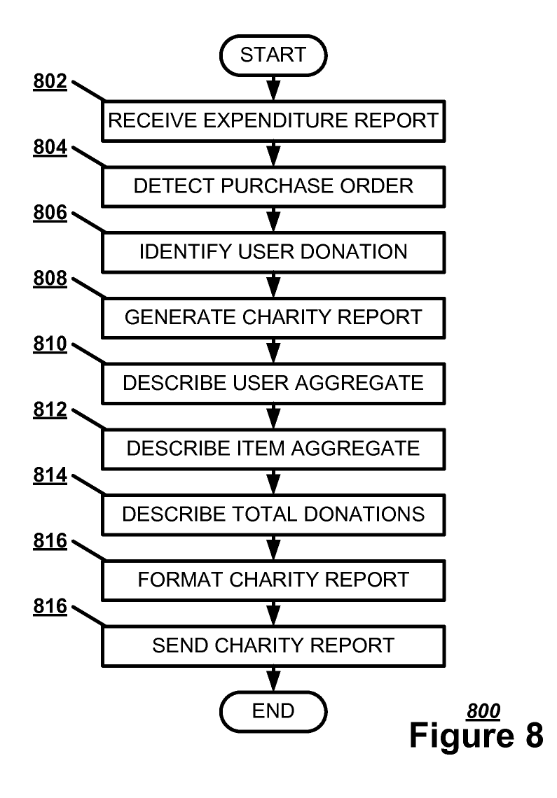

FIG. 7 illustrates, in a flowchart, one embodiment of a method 700 for diverting a charity donation. The centralized internet commerce platform 122 may receive from a user a purchase order 300 for a sales item (Block 702). If the purchase order 300 indicates a user charity donation amount (Block 704), the centralized internet commerce platform 122 may receive an amount designation from the user (Block 706). Otherwise, the centralized internet commerce platform 122 may round a purchase order price to a nearest unit amount (Block 708). The centralized internet commerce platform 122 may set the user charity donation at a rounding amount (Block 710). The centralized internet commerce platform 122 may divert the user charity donation from the purchase order 300 to the charity account 150 (Block 712). If the vendor has indicated a vendor charity donation amount (Block 714), the centralized internet commerce platform 122 may receive an amount designation from the vendor (Block 716). Otherwise, the centralized internet commerce platform 122 may match a vendor charity donation to a user charity donation (Block 718). The centralized internet commerce platform 122 may divert the vendor charity donation from the purchase order 300 to the charity account 150 (Block 720).

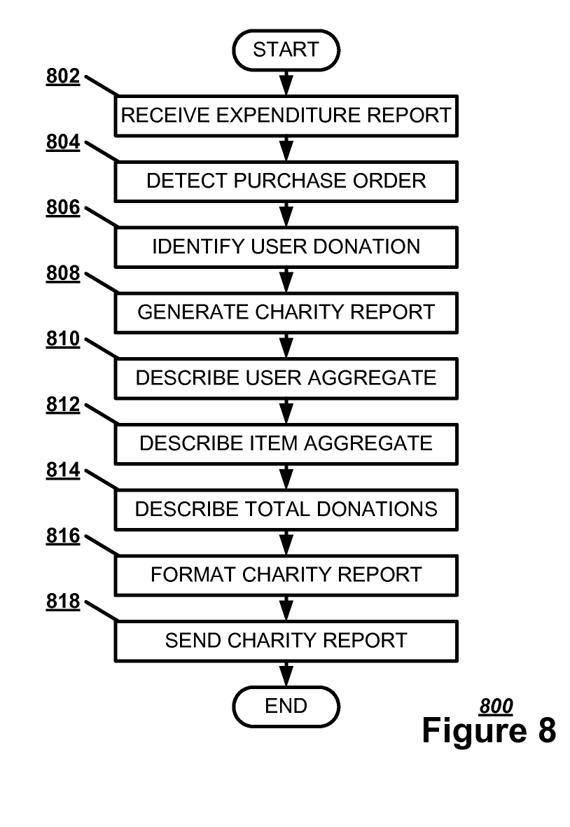

FIG. 8 illustrates, in a flowchart, one embodiment of a method 800 for creating a charity report 400. The centralized internet commerce platform 122 may receive an organization expenditure report 450 from a charity organization owning a charity account 150 (Block 802). The centralized internet commerce platform 122 may detect a purchase order 300 from a user for a sales item of a vendor (Block 804). The centralized internet commerce platform 122 may automatically identify a user charity donation diverted from the purchase order to a charity account 150 of a charity (Block 806). The centralized internet commerce platform 122 may automatically generate a charity report 400 based in part on the user charity donation (Block 808). The centralized internet commerce platform 122 may describe a user aggregate donation 420 in the charity report 400 (Block 810). The centralized internet commerce platform 122 may describe a sales item aggregate donation 430 in the charity report 400, including donations by other users when purchasing that sales item (Block 812). The centralized internet commerce platform 122 may describe the total donations by users of the centralized internet commerce platform 122 to a charity organization in the charity report 400 (Block 814). The centralized internet commerce platform 122 may format the charity report for display by a charity report application 114 (Block 816). The centralized internet commerce platform 122 may send the charity report 400 to at least one of the user, the vendor, or the charity (Block 818).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

1. A machine-implemented method, comprising:
presenting on a centralized internet commerce platform a sales item of a vendor for purchase;
receiving from a user a purchase order at the centralized internet commerce platform for the sales item;
diverting at the centralized internet commerce platform a charity donation from the purchase order to a charity account.

2. The method of claim 1, further comprising:
diverting at the centralized internet commerce platform a user charity donation from the purchase order to the charity account.

3. The method of claim 1, further comprising:
rounding a purchase order price to a nearest unit amount; and
setting a user charity donation at a rounding amount.

4. The method of claim 1, further comprising:
diverting at the centralized internet commerce platform a vendor charity donation from the purchase order to the charity account.

5. The method of claim 1, further comprising:
matching a vendor charity donation to a user charity donation.

6. The method of claim 1, further comprising:
receiving an amount designation from at least one of the user and the vendor.

7. The method of claim 1, further comprising:
receiving a charity designation from at least one of the user and the vendor.

8. The method of claim 1, further comprising:
determining the charity account based in part on a purchase type.

9. The method of claim 1, further comprising:
determining the charity account based in part on a charity donation amount.

10. The method of claim 1, further comprising:
creating the charity account based on a user description.

11. The method of claim 1, further comprising:
creating a charity award upon completion of the purchase order.

12. The method of claim 1, further comprising:
sending a charity award to the user.

13. The method of claim 1, further comprising:
posting a charity badge directly to a social network.

14. A tangible machine-readable medium having a set of instructions detailing a method stored thereon that when executed by one or more processors cause the one or more processors to perform the method, the method comprising:
detecting a purchase order from a user at a centralized internet commerce platform for a sales item of a vendor;
identifying automatically at the centralized internet commerce platform a user charity donation diverted from the purchase order to a charity account of a charity organization;
generating automatically a charity report based in part on the user charity donation; and
sending the charity report to at least one of the user, the vendor, or the charity organization.

15. The tangible machine-readable medium of claim 14, wherein the method further comprises:
describing a user aggregate donation in the charity report.

16. The tangible machine-readable medium of claim 14, wherein the method further comprises:
describing a sales item aggregate donation in the charity report.

17. The tangible machine-readable medium of claim 14, wherein the method further comprises:
receiving an organization expenditure report from the charity organization.

18. The tangible machine-readable medium of claim 14, wherein the method further comprises:
formatting the charity report for display by a charity report application.

19. A centralized internet commerce platform, comprising:
a transceiver that receives a purchase order from a user for a sales item of a vendor; and
a processor that diverts a charity donation from the purchase order to a charity account and automatically generates a charity report based in part on the charity donation.

20. The centralized internet commerce platform of claim 19, wherein the sales item is at least one of an application, a media content piece, a product and a service package.
